(19) United States
(12) Patent Application Publication
(10) Pub. No.: US 2012/0214129 A1
(43) Pub. Date: Aug. 23, 2012

(54) CONNECTING ARRANGEMENT BETWEEN A TOOTH PROSTHESIS AND AN IMPLANT POST

(76) Inventor: Thomas Laux, Steppach-Neusass (DE)

(21) Appl. No.: 13/399,024

(22) Filed: Feb. 17, 2012

(30) Foreign Application Priority Data
Feb. 18, 2011 (DE) 10 2011 011 583.8
May 18, 2011 (DE) 10 2011 101 927.1
Aug. 26, 2011 (DE) 10 2011 111 320.0

(51) Int. Cl. A61C 13/28; A61C 8/00; A61C 13/265

(52) U.S. Cl. 433/173

(57) ABSTRACT

In a connecting arrangement between a tooth prosthesis crown and a head of an implant post between which an intermediate element is arranged engaging both the crown and the implant post head, the intermediate element consist of a spring elastic metal material with inner circumferential segments which elastically project into openings formed in an upper region of the implant post head and outer circumferential segments which elastically project into openings formed in the crown.

### BACKGROUND OF THE INVENTION

The invention resides in a connecting arrangement between a tooth prosthesis crown and an implant post head with an intermediate element arranged in the space between the tooth prosthesis crown and the head of the implant post.

Such connecting arrangements are necessary for fixing a tooth prosthesis top, full prosthesis or partial prosthesis, on an implant post or posts anchored to jaw bones in a way that the prosthesis can be removed.

There are various proposals for such connecting arrangements. They relate to the shape of the head of the implantation post on one hand and to the shape of the crowns on the other hand, which can be disposed onto the implant post heads and which are part of the tooth prosthesis.

U.S. 2010/0159420 discloses such a connecting arrangement wherein the head of the implant post includes a circumferential groove. The crown has a spherically curved inner circumferential surface which cooperates with the outer circumferential surface of a retaining support ring which is also spherically curved and consists of a hard material. The retaining ring surrounds with its inner circumferential surface partially an elastomer ring which is accommodated in the circumferential groove of the implantation post head. The elastomer ring facilitates in cooperation with the circumferential groove of the implant post head an elastic snap-in connection which provides for a locking engagement of the crown on the implant post but which, at the same time, permits a removal of the crown from the implant post.

In this known arrangement however, it is difficult to install the retaining ring in the crown since the largest outer diameter of the spherically curved outer surface of the retaining ring is greater than the diameter of the lower opening formed by the also spherically curved inner circumferential surface of the crown. If the retaining ring consists of metal, it needs to be slotted or, if it consists of a rigid plastic material, it must be deformed correspondingly. But it is even more difficult to remove the retaining ring from the crown when it needs to be exchanged. The elastomer ring has only a limited life span so that the need for an exchange must be expected within a relatively short period.

U.S. Pat. No. 6,981,871 B2 discloses a connecting arrangement wherein the head of the implant post has an upper section with a first diameter and a section disposed below which has a second somewhat larger diameter wherein both sections have a curved outer surface and are separated from each other by an annular groove. The crown has a spherically curved inner circumferential surface. Into this crown which consists for example of stainless steel an engagement cup of elastic material such as nylon is inserted which also has a spherical outer circumferential surface and is provided at its inner circumference with surface areas which are concave in an axial cross-section and which are axially spaced. The upper surface area of the engagement cup extends around the curved circumferential surface area of the upper section of the implant post head and the lower surface area extends around the curved circumferential surface area of the adjacent section of the implant post head which has a somewhat larger outer diameter. The elastic engagement cup consequently provides for an elastic engagement connection with the two axially adjacent sections at two axially spaced locations of the implant post.

Also with this known arrangement, only a limited life of the engagement cup which consists of an elastic and therefore relatively soft material can be expected so that, accordingly, it needs to be replaced from time to time.

U.S. 2010/0055645 discloses another connecting arrangement which realizes the principle of a double locking arrangement for an engagement cup of an elastic material which is inserted into a crown and which is mounted onto an implant post head in a different way. There, the implant post has an implant post head with a spherical outer circumferential surface which is surrounded in an axial cross-section by a concave inner circumferential surface of an apron of the engagement cup and the implant post has furthermore an axially centered and undercut opening into which a knob-shaped axially centered extension of the engagement cup extends. The arrangement consequently resides in a double lock structure on one hand by an elastic locking of the knob-like extension of the locking cup in the opening of the implant post head and, on the other hand, by an engagement of the outer apron of the locking cup by means of the spherical outer or circumferential surface of the implant post head.

Also in this case, the locking cup installed in the metal crown consists of an elastic material such as nylon and consequently has a limited life.

All of the proposed proposals of connecting arrangements between an implant post and a crown as discussed above are embodiments of a common basic structure, wherein an elastically deformable locking element of an elastomer or elastic p which locking element cooperates, because of its elastic deformability, with the contour of the implant post head that consists of a hard metal for fixing the tooth prosthesis in a removably locking manner on the implant post which is anchored in the jaw bone or in the root of a tooth which Is no longer vital. Therefore, all these known embodiments have the problem that the elastomer or non-metallic elastic locking element is a wear part, which has a limited life and must be replaced from time to time.

It is therefore the object of the present invention to provide an improved connecting arrangement between a crown forming a connecting part between a tooth prosthesis and an implant post.

### SUMMARY OF THE INVENTION

In a connecting arrangement between a tooth prosthesis crown and a head of an implant post between which an intermediate element is arranged engaging both the crown and the implant post head, the intermediate element consist of a spring elastic metal material with inner circumferential segments which elastically project into openings formed in the implant post head in an upper region of the crown and outer circumferential segments which elastically project into openings formed in the crown.

The head of the implant post may be a component mounted onto the implant post, particularly in the form of a post top which can be threaded onto the implant post, or an otherwise fixed post cap which is provided at its outer surface with such engagement surfaces for engagement by a tool for mounting the cap. Such a post top or cap may also be considered to be a primary crown mounted onto the implant post which as it is described in EP patent 2 015 700, is arranged together with a compression spring on the implant post and, together with the implant post head, forms a shock absorber. The connecting part of a tooth prosthesis which was called above a crown then is a secondary crown which carries this primary crown.

The invention is included in several embodiments covered by independent claims.

In accordance with claim 1, the intermediate element is in the form of a sleeve which has a lower essentially cylindrical section which is provided with an external thread so that it can be threaded into a corresponding internal thread of the crown and with an upper preferably inwardly projecting section which, by means of an axial slot, is formed to a circularly extending segment or is divided into circumferential sections by axial slots arranged spaced in circumferential direction. The circumferential segment or segments are provided with locking elements which cooperate with a locking element formed on the implant post head. The locking elements of the segments are preferably engagement projections which can engage into an annular groove provided in the head of the implant post. However the arrangement may also be reversed so that the engagement projections are arranged on the implant post head and can be engaged in engagement recesses of the segments.

Preferably there are several segments provided which are distributed over the circumference of the intermediate element. Basically, however, it would be sufficient to provide a single element which has a wide axial slot formed in the upper section thereof and which then, in contrast to a closed ring, has a radial elasticity similar to a structure with several separate slots.

The intermediate element is in the form of a sleeve which has a lower section which is essentially cylindrical and is provided with an axial slot, so as to form a circumferentially extending single resilient segment, or it is divided by several axial slots into a plurality of individual circumferential segments. The segment or segments is or are provided at the outside thereof with an engagement element which can be brought into engagement with a corresponding engagement element formed at the inner surface of the crown. The engagement element includes an upper preferably inwardly conically projecting section which also forms a circumferentially extending segment or several circumferential segments formed by several axial slots cut into the inwardly projecting section wherein the segment or segments are provided at the inner surfaces thereof with an engagement element for engagement with a corresponding engagement element formed on the implant post. Preferably, the engagement elements are again engagement projections which can be engaged in a circumferential groove at the inner surface of the crown or, respectively, the implant post.

In accordance with the independent claim 12, the intermediate element is in the form of an axially slotted annular spring. The spring has outer areas which are in engagement with a complementary formation at the inner wall of the crown and radially inner areas which are in engagement with a complementary formation at the implant post wherein at least one of these two engagements, preferably that with the implant post is lockable. The annular spring may have a radially waving shape so as to form the mentioned radially inner and radially outer areas by radially and radially outer wave areas or the annular spring may have a circular base body on which the radially inner and radially outer areas are formed by areas projecting from the base body radially inwardly and, respectively, radially outwardly. Also, mixed forms are possible. The cross-section of the annular spring does not need to be exactly circular and also not evenly rounded, it may also be rather rectangular if the engageability is facilitated by correspondingly inclined ramp surfaces provided at the counter element.

In all cases, the invention has the advantage that elastomer components with are subject to wear are not needed and, as a result, a durable precisely effective connecting arrangement can be provided for releasably connecting a tooth prosthesis to an implant post.

In any case, the intermediate element consists of metal as explained above. In a particular further development of the invention, the intermediate element may consist of a nickel-titanium alloy. Such a nickel-titanium alloy material is known under the trade name “NiTinol” and is special in that it has shape memory properties. If such an intermediate element should, in time, be subject to a deformation as a result of the continuous load changes by chewing and, as a result, the engagement between the implant post head and the crown would lose strength, such an intermediate element of a nickel titanium alloy can be returned to its original shape for example by means of hot water.

The invention will become more readily apparent from the following description thereof with references to the accompanying drawings.

### BRIEF DESCRIPTION OF THE DRAWINGS

It is shown in:

FIG. 1 a first embodiment of the invention in an exploded view,

FIG. 2 the embodiment of FIG. 1 assembled in an axial cross-sectional view,

FIG. 3 a second embodiment of the invention in an exploded view, all parts being shown in an axial cross-section,

FIG. 4 the embodiment of FIG. 3 assembled in an axial cross-sectional view,

FIG. 5 a third embodiment of the invention in an exploded view wherein the crown and the post cap are shown cut along axial plane and the annular spring is shown in a top view, and

FIG. 6 an embodiment as shown in FIG. 5 assembled in an axial cross-sectional view.

### DETAILED DESCRIPTION OF VARIOUS EMBODIMENTS

In all embodiments as shown in the drawings, the connecting arrangement includes a post cap 1 (below called “primary crown”) which forms the head of an implant post which is not shown in the drawings, a crown 2 (below called “secondary crown”) and an intermediate element 3 making an engageable connection between these two components possible.

The implant post itself is not part of the present invention and therefore, is not described in detail. Also, the design of the implant post head in the form of a primary crown which is disposed on the implant post as shown in the exemplary embodiment or as an integral part of the implant post as well as the connection between the primary crown and the implant post including the configuration of a shock absorber arrangement between the primary crown and the implant post are not part of, or important for, the present invention and are not described in detail.

The secondary crown is a known part of a tooth prosthesis which may be in the form of a full or partial prosthesis. Also, the design of the outer surfaces of the secondary crown for the connection with the rest of the tooth prosthesis are not part of the invention.

Rather, the connection arrangement according to the invention comprises only the respective intermediate element 3 of the various embodiments as well as the counter elements of the primary crown (or respectively, of another implant post head which may be formed for example as an integral part of the implant post) and the secondary crown.

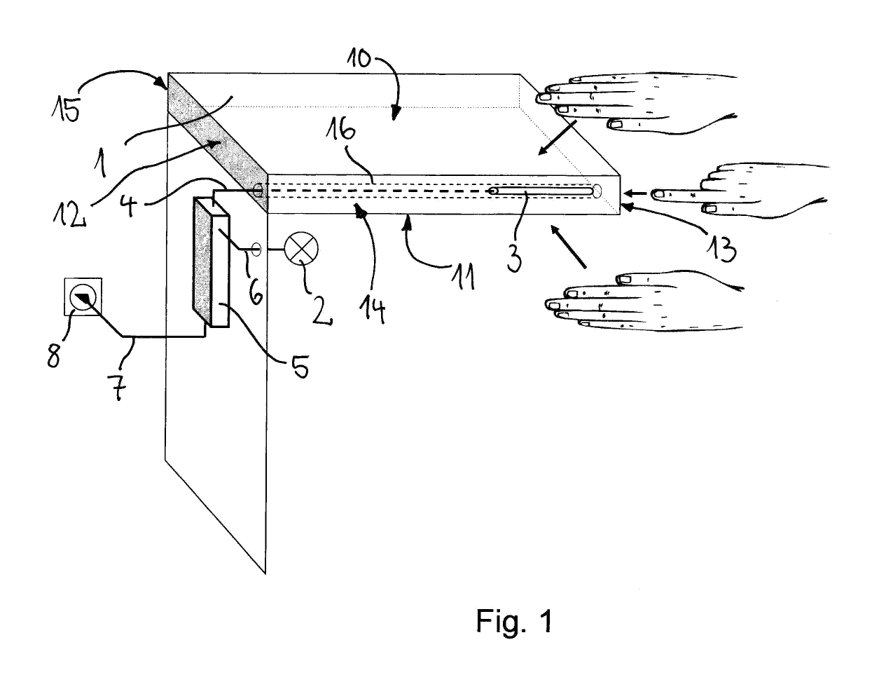

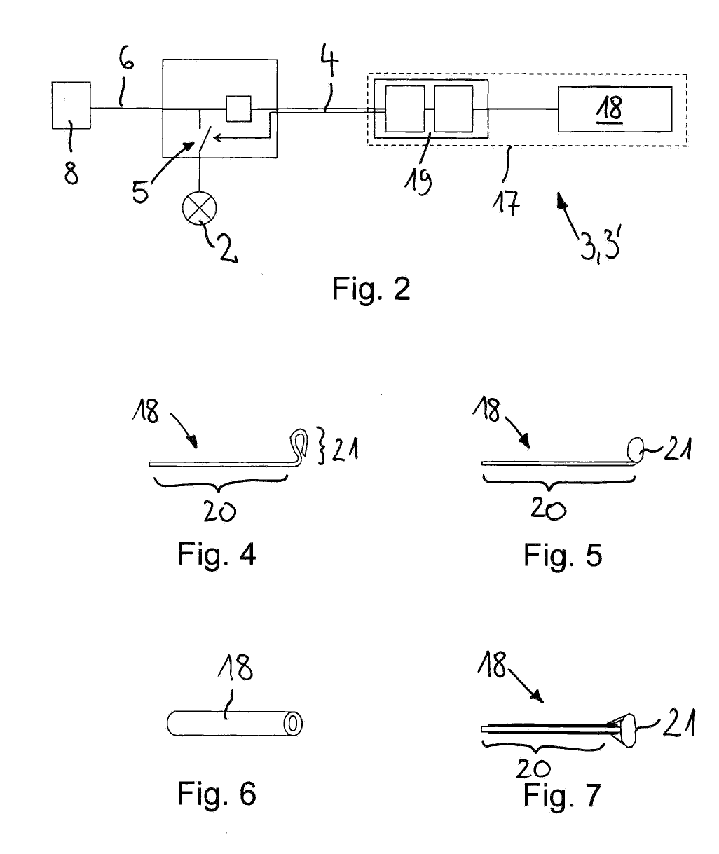

A first, preferred embodiment of the connecting arrangement according to the invention is shown in FIGS. 1 and 2 wherein FIG. 1 shows the components primary crown 1, secondary crown 2 and intermediate element 3 in an exploded representation, each in an axial cross-sectional view and FIG. 2 shows the assembled arrangement in an axial cross-sectional view.

The intermediate element 3 includes a lower essentially cylindrical section 31 and an adjacent upper section 32 which extends conically inwardly and has an essentially truncated cone shape wherein, at the transition between the lower section 31 and the upper section 32, a radially inwardly extending shoulder 33 with an upwardly inclined shoulder surface 34 is formed.

The essentially cylindrical lower section 31 of the intermediate element 3 is provided at its outer circumference with a thread 35. The secondary crown 2 has a top wall 21 with an adjacent sleeve part 22 with an outer surface on which form-locking elements are provided for anchoring interlocking means in a lower opening of the tooth prosthesis. The inner wall surface of the secondary crown is provided with an internal thread 35 which is complementary to the thread 35 of the intermediate element 3. Adjacent the internal thread 23 on the inside wall surface of the sleeve part 22 of the secondary crown 2, there is above a radially inwardly extending inner shoulder 24 a conical wall section 25 which extends up to the inner wall surface of the top wall 21. As apparent from FIG. 1, the upper section 32 of the intermediate element 3 is divided into a plurality of circumferential segments 37 by axial slots 36 arranged at the circumference thereof in an evenly spaced manner. These segments 37 have at their inner sides each an inwardly extending projection 28, which serves as an engagement element. In the exemplary embodiment, this projection 38 is formed by an annular bead which is formed on the inner wall of the segments 37 and which has, in an axial cross-section, the form of a circle segment. The projection could of course also be formed by at least one nub but the annular bead configuration appears to be the most suitable form for efficient manufacture.

The primary crown which forms the implant post head, has a top wall part 11 and an adjacent sleeve part 12. The inside configuration of the primary crown is adapted to a connection with the implant post, which is not shown, and a shock absorber spring; they do not need to be described in connection with the invention.

The outside surface of the sleeve part 12 of the primary crown 1 has in its lower area an outwardly extending shoulder 13 which, as shown in FIG. 2 cooperates with the lower edge area 26 of the sleeve part 22 of the secondary crown 2. Adjacent this shoulder 13, the primary crown 1 has an upwardly extending sleeve-like cylindrical section 14, which is adapted to a complementarily extending lower cylindrical inner wall area of the lower part 31 of the intermediate element 3. Above the cylindrical section 14, there is another inwardly shoulder 15 followed by an upper sleeve wall section 16 of conical shape in which a circumferential groove 17 is formed which has circular segment-like axial cross-section.

The circumferential groove 17 in the outer surface of the sleeve part 12 of the primary crown 1 serves as an engagement structure and cooperates with the projection 38 formed on the segment 37 of the upper section 32 of the intermediate element 3.

As apparent from FIG. 2, the segments 37 of the upper section 32 of the intermediate element 3 have in the space between the conical wall area section 25 of the sleeve part 22 of the secondary crown and the upper conical wall segment 16 of the primary crown 1 because of the radial spacing between these wall areas from each other sufficient radial play to make the engagement and disengagement by a certain radial displacement of the segments 37 possible. Since the segments 37 are separated from one another by the radial slots 36, the mentioned radial displacement is facilitated as the segments 37 have spring properties as a result of the elasticity of the metal of which the intermediate element 3 consists.

For use, the intermediate element 3 is threaded into the secondary crown. Herein, the threading movement may be limited in that the shoulder surface 34 of the intermediate element 3 abuts the inner shoulder 24 of the inner wall of the sleeve part 22 of the secondary crown 2. Alternatively, another stop may be provided to obtain a predetermined position of the intermediate element 3 in the secondary crown 2, in particular a radially outwardly projecting annular bead formed at the lower end of the sleeve-like intermediate element 3 which cooperates with a corresponding counter surface of a circumferential groove or a shoulder of the secondary crown acting as a stop. It is also possible to provide for a certain adjustability of the position of the intermediate element 3 within the secondary crown 2 for example by certain engagement means in the area of the thread connection. The spring elasticity of the segments 37 of the intermediate element 3 can be adjusted in several ways, for example by a selection of the radial thickness of the segments 37, the number and width of the axial slots 36 and as a result, also the number and circumferential width of the segments 37. In this way and by the selection of the relative axial position of the projections 38 of the segments 37 and the circumferential groove 17 of the primary crown 1, the tautness and the pretension of the engagement connection are adjustable.

Different from the described embodiment using a plurality of segments 37, the upper section 32 of the intermediate element 3 may also be formed by a single circumferentially extending segment in such a way that this upper section includes an axial slot which may be relatively wide to provide for the engagement function.

In the exemplary embodiment, the engagement means are formed by projections 38 provided On each segment 37 and the circumferential grooves 17 formed in the primary crown 1. The arrangement however could also be reversed, so that the primary crown has an engagement projection for example in the form of a circumferential bead or in the form of nubs or bead segments and the segments 33 are provided with engagement recesses.

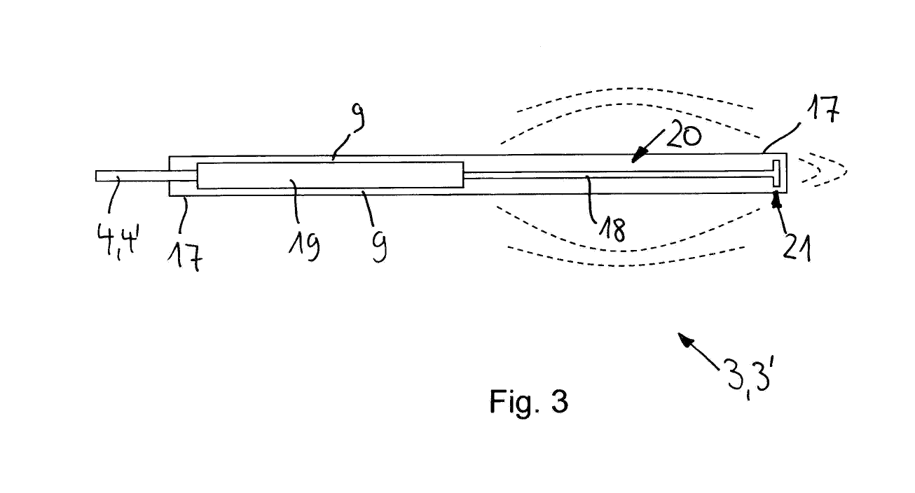

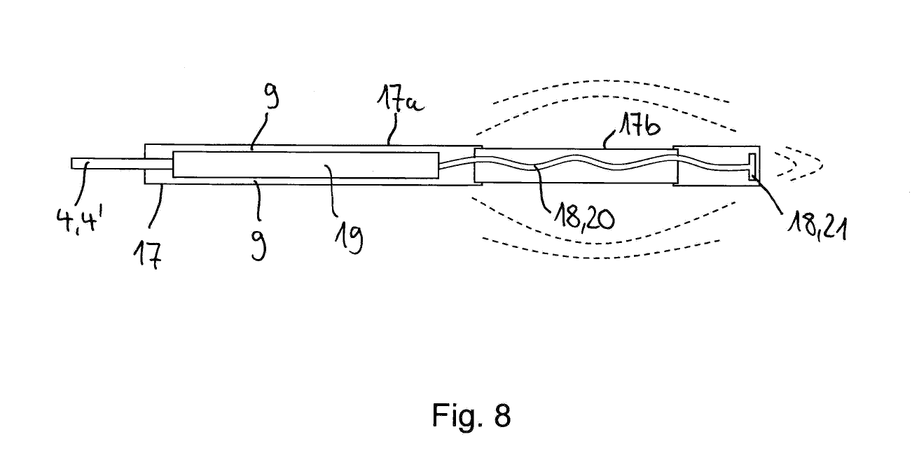

A second embodiment of the connecting arrangement according to the invention is shown in FIGS. 3 and 4.

The essential difference between the above-described embodiment according to FIGS. 1 and 2 and the embodiment according to FIGS. 3 and 4 resides in the connection between the intermediate element 3 and the secondary crown 2.

While the intermediate element 3 of the embodiment as shown in FIGS. 1 and 2 is provided at its lower section 31 with an external thread 35 which cooperates with a corresponding internal thread 23 of the sleeve part 22 of the secondary crown 2, in the embodiment according to FIGS. 3 and 4, a snap-in engagement connection is provided between the sleeve part 22 of the secondary crown 2 and the lower section of the intermediate element 3. To this end, the sleeve part 22 of the secondary crown includes in the lower area of its inside wall an annular groove 27, which forms an engagement recess and the slightly conical lower section 31 of the intermediate element 3 is divided by axial slots 39 arranged in circumferentially spaced relationship into a number of separate circumferential segments 40, which are provided at their outer surfaces each with a projection 41 which forms an engagement element which is engaged in the annular groove 27 of the sleeve part 22 of the secondary crown. The projection 41 of each segment 40 is again in the form of an annular segment bead but it could also be in the form of at least one nub.

Generally, the design of the primary crown 1, the secondary crown 2 and the intermediate element 3 corresponds to those of FIGS. 1 and 2 so that they do not need to be described again. Rather, the same reference numerals have been used for the same or functionally the same elements.

Like in the embodiments of FIGS. 1 and 2, the segments of the upper section 32 of the intermediate element 3 have, in the assembled state of the components between the respective conical wall surface areas 25 and 16 of the secondary crown and the primary crown sufficient radial play to facilitate the necessary spring-elastic displacement of the segments 37 to permit engagement and disengagement of the projections 38 with the circumferential groove 17 of the primary crown 1. In contrast, when the second crown 2 is placed together with the intermediate element 3 onto the primary crown 1, the segments 40 of the lower section 31 of the intermediate element 3 have no radial play capability between the sleeve part 32 of the secondary crown 2 and the sleeve surface section 14 of the sleeve part 12 of the primary crown 1. In this way, the snap-in connection of the lower section 31 of the intermediate element 3 with the sleeve part 22 of the secondary crown 2 is secured whenever the secondary crown 2 is mounted, together with the intermediate element 3 onto the primary crown 1, that is, the intermediate element 3 with the segments 40 of its lower section 31 cannot be disengaged from the annular groove 27 of the sleeve part 22, when the secondary crown 2 is disposed on the primary crown 1. In this way, it is made sure that, upon removal of the tooth prosthesis and also the secondary crown 2 from the implant post, that is, in this case, from the primary crown 1, a disengagement occurs exclusively between the projections 3 of the upper segments 37 of the intermediate element 3 and the circumferential groove 17 of the primary crown 1 but the secondary crown 2 can not possibly be released from the intermediate element 3 so that this element will not remain on the primary crown 1 upon removal of the secondary crown 2.

The possible variations mentioned in connection with the embodiment according to FIGS. 1 and 2 are also applicable in connection with the embodiment according to FIGS. 3 and 4. Also here, the upper and/or lower section of the intermediate element may be in the form of several segments or a single segment and the arrangement of the projections on the one part and the engagement recesses on the other for example in the form of circumferential grooves providing for the engagement function may be reversed.

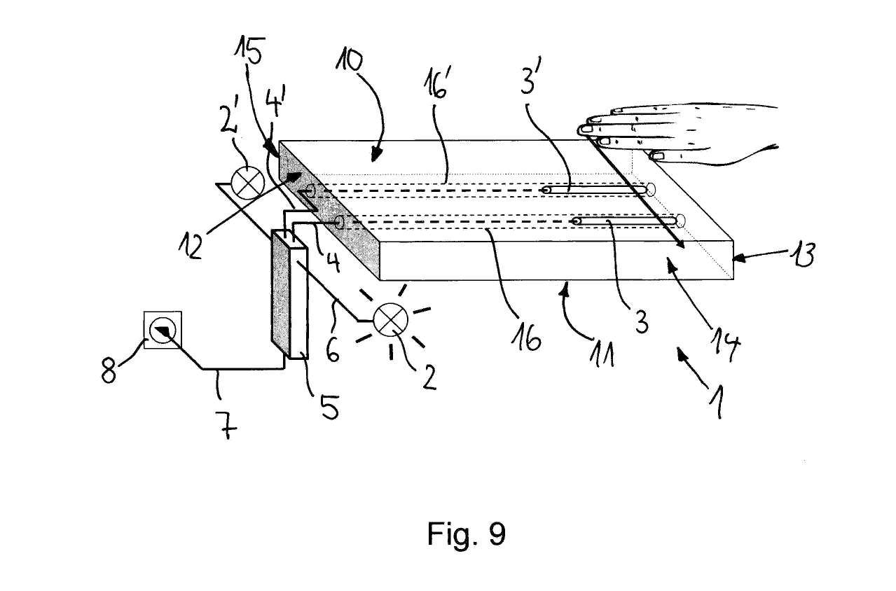

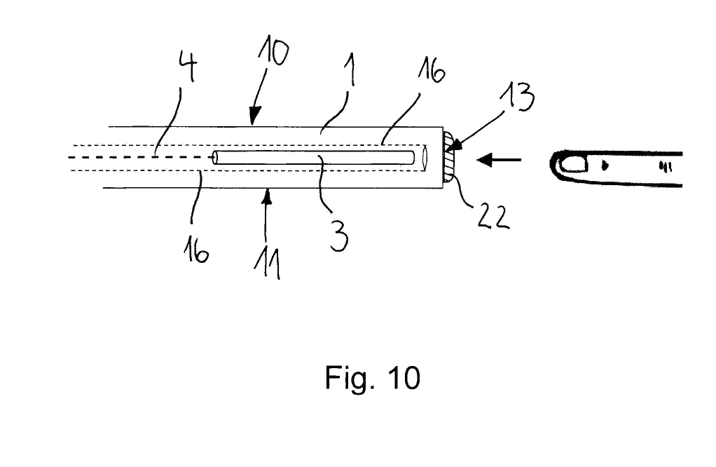

A third embodiment of a connecting arrangement according to the invention is shown in FIGS. 5 and 6. This embodiment according to FIGS. 5 and 6 differs from the embodiments according to FIGS. 1-4 in that the intermediate element 3 is not in the form of a sleeve which cooperates via spring elements (segments 37 with projections 38) at least with the primary crown 1 for elastic engagement, but is in the form of an annular spring 52 which engages, on one hand, with radially outer areas the secondary crown 2 (which does not necessarily have to be, but can be, an elastic engagement) and, on the other hand, with radially inner areas of the primary crown 1.

The annular spring 52 which forms the, intermediate element in the embodiment of FIGS. 5 and 6 is shown in FIG. 5 in a top view to better show its shape whereas the primary crown 1 and the secondary crown 2 are shown in an axial cross-sectional view.

The annular spring 52 consists of an annular body which is provided with a slot 51 and, at circumferentially evenly spaced locations, with small outwardly extending protrusions forming waves 53. These waves 53 form radially outwardly projecting areas which as shown in FIG. 6 extend into an annular groove 28 in the inner wall of the secondary crown 2. Since the annular spring has the slot 51, it is easily insertable into the annular groove 28 of the secondary crown 2.

Between the radially outwardly extending waves 23, the inner circumferential area of the annular body 52 has radially inner areas which as also shown in FIG. 6 are received in an annular groove 18 of the primary crown 1 for engagement therewith. As also shown in FIG. 6, the annular spring has a rectangular ring cross-section. The upper groove flank surface of the annular groove 18 of the primary crown 1 is inclined so that a disengagement of the annular spring from the annular groove is facilitated and above the annular groove 18 the primary crown 1 is curved or inclined so as to form a ramp-like outer surface area which provides for a radial expansion, that is, opening of the annular spring upon insertion of the secondary crown 2 onto the primary crown 1 followed by the engagement of the spring into the annular groove 18.

Different from the described exemplary embodiment of the annular spring, it is also possible to use a spring which has a circular ring cross-section and is provided with a radial wave shape and which may also be slotted or which may have no slot. Also springs with cross-sectional shapes wherein only the radially inwardly facing o-ring cross-section part is round or bead-like shaped may be used.

In all of the described embodiments, the intermediate element 3 may consist of a Nickel-titanium alloy which has shape memory properties as mentioned already in the general description part.

What is claimed is:

1. A connecting arrangement between a tooth prosthesis crown (2) and a head (.1) of an implant post, including: an intermediate element (3) which is arranged between the crown (2) and the implant post head (1) and which cooperates, on one hand, with the inner surface of the crown (2) in a form-locking manner and, on the other hand, with an engagement element (17) of the implant post head (1) for snap-in engagement therewith, said intermediate element (3) consisting of a spring-elastic material and having a sleeve-shape with a lower section (31) adjacent the implant post head (1) and an upper section (32) facing a top wall of the crown (2), the lower section (31) being essentially cylindrical and provided at its outer circumference with a thread (35) onto which the crown (2), which is provided with a complementary inner thread (23) is threaded, and the upper section (32) having at least one axially extending slot or circumferentially spaced axially extending slots (36) providing for circumferential segments (37) which each have at their inner side an engagement element (38) cooperating with the engagement element (17) of the implant post head (1), the circumferential segments (37) being radially elastically bendable to permit the snap-in engagement upon insertion of the intermediate element (3) onto the implant post (1).

2. The connecting arrangement according to claim 1, wherein the engagement element (38) of each circumferential segment (37) of the upper section (32) of the intermediate element (3) is formed by a projection (38). which cooperates with an engagement recess (17) on the implant post head (1).

3. The connecting arrangement according to claim 1, wherein the upper section (32) of the, intermediate element (3) is in the form of an upwardly narrowing truncated cone.

4. The connecting arrangement according to claim 3, wherein the truncated cone-shaped upper section (32) is connected with the essentially cylindrical lower section (31) of the intermediate element (3) via a radially inwardly extending shoulder part (33) which has an upwardly facing shoulder surface (34) facing a complementary shoulder surface (24) of a radially inwardly extending part of the inner wall surface of the crown (2) forming a stop.

5. The connecting arrangement according to claim 1, wherein the intermediate element (3) consists of a nickel-titanium alloy with shape-memory properties.

6. A connecting arrangement, between a tooth prosthesis crown (2) and a head (1) of an implant post, including: an intermediate element (3) which is arranged between the crown (2) and the implant post head (1) and which cooperates on one hand with the inner surface of the crown (2) for form-locking engagement therewith and, on the other hand, with an engagement structure (17) of the implant post head (1) for engagement with the implant post head (1), the intermediate element (3) consisting of a spring elastic material and being in the form of a sleeve with a lower section (31) having an opening for receiving the implant post head (1) and an upper section (32) adjacent an upper end wall (21) of the primary crown (2), the lower section (31) of the intermediate member (3) having an essentially cylindrical shape provided at its circumference with circumferentially spaced axial slots (39) so as to form segments (40) which are elastically bendable outwardly and which are provided at their radially outer side with engagement elements (41) cooperating with a counter engagement structure (27) formed at the inner wall of the crown (2), and the upper section (32) including axial slots (36) formed in circumferentially spaced relationship in the upper section (32) forming segments (37) which are elastically bendable outwardly and provided at the inner side thereof with engagement elements (38) for engagement with a counter engagement structure (17) formed on the implant post head (1).

7. The connecting arrangement according to claim 6, wherein the engagement element (38) of each circumferential segment (37) of the upper section (32) of the intermediate element (3) is formed by a projection (38) which cooperates with an engagement recess (17) on the implant post head (1).

8. The connecting arrangement according to claim 6, wherein the engagement element (41) of each segment (40) of the lower section (31) of the intermediate element (3) is formed by a projection (41) engaging in an annular groove (27) formed in the inner wall of the crown (2).

9. The connecting arrangement according to claim 6, wherein the upper section (32) of the intermediate element (3) is in the form of an upwardly narrowing truncated cone.

10. the connecting arrangement according to claim 9, wherein the truncated cone-shaped upper section (32) is connected with the essentially cylindrical lower section (31) of the intermediate element (3) via a radially inwardly extending shoulder part (33) which has an upwardly facing shoulder surface (34) which faces a complementary shoulder surface (24) of a radially inwardly extending part of the inner wall surface of the crown (2) forming a stop.

11. The connecting arrangement according to claim 6, wherein the intermediate element (3) consists of a nickel-titanium alloy with shape-memory properties.

12. A connecting arrangement between a tooth prosthesis crown (2) and a head (1) of an implant post, including: an intermediate element (3) which is arranged between the crown (2) and the implant head (1) and which cooperates on one hand with the inner surface of the crown (2) in a form-locking manner and, on the other hand, with the implant post head (1) for elastic engagement therewith, the intermediate element (3) consisting of a spring-elastic material and being in the form of an annular spring which has radially outer areas (53) forming engagement elements for engagement with an engagement structure (28) in an upper region of the inner wall surface of the crown (2) and radially inner areas for engagement in a counter structure (18) formed on the implant post head (1).

13. The connecting arrangement according to claim 12, wherein the annular spring (52) includes an axial slot (51) and a plurality of projections or bulges (53) extending radially outwardly.

14. The connecting arrangement according to claim 13, wherein the annular spring (52) has a rectangular ring, cross-section and the engagement structure (18) formed on the implant post head (1) is an annular groove with an upper groove flank which is inclined to form a ramp surface and the implant post head (1) has above the annular groove (18) an upwardly converging inclined ramp surface area.

15. The connecting arrangement according to claim 12, wherein the annular spring (52)is provided at its circumferential surface with wave-like outer edge areas (53) for engagement with the engagement structures (28) and inner wave-like areas which form engagement elements for engagement with the with the implant post head engagement structure (18).

16. The connecting arrangement according to claim 12, wherein the intermediate element (3) consists of a nickel-titanium alloy with shape-memory properties.
